(19) United States
(12) Patent Application Publication
(10) Pub. No.: US 2008/0107986 A1
(43) Pub. Date: May 8, 2008

(54) Hydrophobic, Salt-Like Structured Silicate

(76) Inventors: Eduard Michel, Frankfurt am Main (DE); Ruediger Baur, Eppstein-Niederjosbach (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/596,639

(22) PCT Filed: Apr. 28, 2005
(86) PCT No.: PCT/EP05/04542

§ 371 Date: Jul. 24, 2007

(30) Foreign Application Priority Data
May 14, 2004 (DE) 10 2004 024 001.9

(51) Int. Cl. G03G 5/00

(52) U.S. Cl. 430/84; 430/135

(57) ABSTRACT

A salt-like hydrophobic structured silicate, wherein the cation of the salt-like structured silicate is a low molecular weight organic cation or a combination thereof with NH₄⁺, H₃O⁺, alkali metal, alkaline earth metal, earth metal and/or a transition metal ion. The anion of the salt-like structured silicate is an island, ring, group, chain, band, layer or tectosilicate or a combination thereof. The structured silicate is produced by (a) reacting a structured silicate, whose cation is NH₄⁺, H₃O⁺, an alkali metal, alkaline earth metal, earth metal, and/or transition metal ion or a combination thereof, and whose anion of which is an island, ring, group, chain, band, layer or tectosilicate, or a combination thereof, in an aqueous dispersion with a low molecular weight organic cation; (b) adding to and intensively blending with the aqueous structured silicate dispersion a hydrophobic compound from the group of waxes and metal soaps in a quantity ranging from 0.2 to 200% by weight of the salt-like structured silicate in step (a) before, during and/or after step(a) is carried out and by (c) optionally removing, drying and isolating in the form of a powder the salt-like, hydrophobic structured silicate produced in step (b).

The present invention relates to the field of charge controlling agents in the sense of a component which selectively influences electrostatic charging properties in a matrix.

In electrophotographic recording processes, a “latent charge image” is generated on a photoconductor. This “latent charge image” is developed by application of an electrostatically charged toner, which is then transferred, for example, to paper, textiles, film or plastic, and fixed, for example, by means of pressure, radiation, heat or the action of solvent. Typical toners are one- or two-component powder toners (also called one- or two-component developers), and special toners, such as e.g. magnetic toners, liquid toners or polymerization toners, are moreover also employed. Polymerization toners are to be understood as meaning those toners which are formed e.g. by suspension polymerization (condensation) or emulsion polymerization and lead to improved particle properties of the toner. The term also means those toners which are produced in non-aqueous dispersions.

The specific charge q/m (charge per unit weight) of a toner is a measure of its quality. In addition to the symbol and the level of the electrostatic charging, rapid achievement of the desired charge level, the constancy of this charge over a relatively long activation period and the insensitivity of the toner to climatic influences, such as temperature and atmospheric humidity, is an important quality criterion.

Both positively and negatively chargeable toners are used in copiers and laser printers, according to the type of process and apparatus.

In order to obtain electrophotographic toners or developers having either positive or negative charging, charge controlling agents are often added. Since toner binders frequently show a marked dependency of the charging on the activation time, the task of a charge controlling agent is on the one hand to establish the symbol and level of the toner charging, and on the other hand to counteract the charging drift of the toner binder and to ensure constancy of the toner charging. Furthermore, it is important in practice that the charge controlling agents have an adequate heat stability-and a good dispersibility. Typical temperatures for incorporating charge controlling agents into the toner resins are between 100° C. and 200° C. if kneaders or extruders are used. A heat stability of 200° C. is accordingly of great advantage. It is also important for the heat stability to be. ensured over a relatively long period of time (approx. 30 minutes) and in various binder systems.

For a good dispersibility, it is advantageous if the charge controlling agent shows no wax-like properties, no tackiness and a melting or softening point of >150° C., preferably >200° C. Tackiness often leads to problems in metering into the toner formulation, and low melting or softening points can mean that no homogeneous distribution is achieved during the dispersing in, since the material merges in droplet form in the carrier material.

Typical toner binders are polymerization, polyaddition and polycondensation resins, such as styrene, styrene acrylate, styrene-butadiene, acrylate, polyester and phenol-epoxy resins, as well as cycloolefin copolymers, individually or in combination, which can also contain further constituents, e.g. coloring agents, such as dyestuffs and pigments, waxes or flow auxiliaries, or can acquire these afterwards as additives, such as highly disperse silicas.

Charge controlling agents can also be employed for improving the electrostatic charging of powders and lacquers, in particular in triboelectrically or electrokinetically sprayed powder coatings, such as are used for surface coating of objects of, for example, metal, wood, plastic, glass, ceramic, concrete, textile material, paper or rubber.

Epoxy resins, carboxyl and hydroxyl group-containing polyester resins, polyurethane resins and acrylic resins, together with the conventional curing agents, are typically employed as powder coating resins. Combinations of resins are also used. Thus, for example, epoxy resins are frequently employed in combination with carboxyl and hydroxyl group-containing polyester resins.

It has furthermore been found that charge controlling agents can considerably improve the charging and the charge stability properties of electret materials, in particular electret fibers. Typical electret materials are based on polyolefins, halogenated polyolefins, polyacrylates, polyacrylonitriles, polystyrenes or fluorinated polymers, such as, for example, polyethylene, polypropylene, polytetrafluoroethylene and perfluorinated ethylene and propylene, or on polyesters, polycarbonates, polyamides, polyimides or polyether-ketones, on polyarylene sulfides, in particular polyphenylene sulfides, on polyacetals, cellulose esters, polyalkylene terephthalates and mixtures thereof. Electret materials, in particular electret fibers, can be employed, for example, for extremely fine dust filtration. The electret materials can obtain their charge by corona charging or tribocharging.

Charge controlling agents can furthermore be used in electrostatic separation operations, in particular in separation operations on polymers. Without charge controlling agents, low density polyethylene (LDPE) and high density polyethylene (HDPE) become charged triboelectrically in a substantially similar manner. After addition of charge controlling agents, LDPE becomes highly positively charged and HDPE highly negatively charged, and can thus be easily separated. In addition to the external application of charge controlling agents, incorporation thereof into the polymer is also possible, in order, for example, to shift a polymer within the triboelectric voltage series and to obtain a corresponding separating action. Other polymers, such as e.g. polypropylene (PP) and/or polyethylene terephthalate (PET) and/or polyvinyl chloride (PVC), can likewise be separated from one another in this manner.

Salt minerals can also be separated if an agent which improves the substrate-specific electrostatic charging has been added to them beforehand (surface conditioning).

Charge controlling agents are furthermore employed as electroconductivity providing agents (ECPA) in inks for inkjet printers and for electronic inks or electronic paper.

WO 01/40878 A1 discloses the use of salt-like structured silicates as charge controlling agents. However, these charge controlling agents are usually sensitive to various atmospheric humidity conditions.

The object of the present invention was to discover active and ecotoxicologically acceptable charge controlling agents which have a high rapid charging and high charge stability, and moreover show only a low sensitivity to various atmospheric humidity conditions, in particular high atmospheric humidities. They should furthermore be very readily dispersible, without decomposition, in various toner binders used in practice, such as polyesters, polystyrene acrylates or polystyrene-butadienes/epoxy resins and cycloolefin copolymers. Their action should furthermore be largely independent of the resin/carrier combination, in order to open up a wide scope of use. They should likewise be readily dispersible, without decomposition, in the usual powder coating binders and electret materials, such as e.g. polyester (PES), epoxide, PES-epoxy hybrid, polyurethane, acrylic systems and polypropylenes.

In respect of their electrostatic efficiency, the charge controlling agents should already be active at the lowest possible concentration (1% or less) and should not lose this efficiency in combination with carbon black or other coloring agents. It is known that coloring agents can have in some cases a lasting influence on the triboelectric charging of toners.

Surprisingly, it has now been found that the hydrophobic salt-like structured silicates described below meet the above requirements.

The present invention therefore provides a hydrophobic salt-like structured silicate, wherein the cation of the salt-like structured silicate is a low molecular weight organic cation or a combination thereof with NH₄⁺, H₃O⁺, an alkali metal ion, alkaline earth metal ion, earth metal ion and/or a transition metal ion, the anion of the salt-like structured silicate is an island, ring, group, chain, band, layer or three-dimensional silicate or a combination thereof, and which is obtainable by
(a) reacting a structured silicate, the cation of which is NH₄⁺, H₃O⁺, an alkali metal ion, alkaline earth metal ion, earth metal ion, a transition metal ion or a combination thereof, and the anion of which is an island, ring, group, chain, band, layer or three-dimensional silicate or a combination thereof, with a low molecular weight organic cation in aqueous dispersion, and
(b) before, during and/or after carrying out step (a), adding to the aqueous dispersion of the structured silicate one or more hydrophobic compounds from the group consisting of waxes and metal soaps in an amount of from 0.2 to 200 wt. %, for example 1 to 200 wt. %, preferably 0.5 to 150 wt. %, particularly preferably 1 to 100 wt. %,, based on the salt-like structured silicate according to (a), with intensive thorough mixing, and
(c) optionally freeing the hydrophobic salt-like structured silicate formed in step (b) from the liquid medium, drying it and isolating it as a powder.

It is known to add to the binder of an electrophotographic toner relatively large amounts of wax, for example 3 to 5 wt. %, based on the weight of the binder, in order, for example, to separate off the toner in the photocopying process more easily from the photoconductor (cold anti-offset) or the fixing rolls (hot anti-offset) or also in order to lower the glass transition point of the polymeric binder. However, the object according to the invention is not achieved by the external addition of wax. Only by the treatment according to the invention of the salt-like structured silicate is hydrophobizing of the charge controlling agent effected in a manner such that the desired charge controlling properties are achieved and are rendered insensitive to environmental influences, in particular to relatively high atmospheric humidity.

It is presumed that the hydrophobic compound, that is to say the wax or the metal soap, is embedded between the organic ions of the structured silicates and/or adsorbed on to the surface of the salt-like structured silicates.

According to the conventional definition, the structured silicates mentioned are based on the following empirical formulae:

for island silicates [SiO₄]⁴⁻, for group silicates [Si₂O₇]⁶⁻, for ring silicates [SiO₃]n²⁻, for chain silicates [SiO₃]m²⁻, for band silicates [Si₄O₁₁]m⁶⁻, for layer silicates [Si₂O₅]ₘ²⁻ and for three-dimensional silicates [AlₐSi₁₋ₐO₂]ₘ^{a-}, wherein n=3, 4, 6 or 8, m is an integer and ≧1 and 0<a<1. Structured silicates are often accompanied by further low molecular weight anions, such as e.g. OH⁻, F⁻, Cl⁻, Br⁻, I⁻, acetate, BO₃³⁻, BO₂(OH)²⁻, BO(OH)₂⁻, HCO₃⁻, CO₃²⁻, NO₃⁻, HSO₄⁻, SO₄²⁻, H₂PO₄⁻, HPO₄²⁻, PO₄³⁻, HS⁻, S²⁻.

Furthermore, individual Si atoms in structured silicates can be substituted in some cases by other atoms, such as e.g. Al, B, P or Be (alumosilicates, borosilicates etc.). Naturally occurring or also synthetically prepared structured silicates are furthermore distinguished in that they contain one or more different cations which are often readily exchangeable, such as e.g. Na⁺, K⁺, Mg²⁺, Ca²⁺, and e.g. can be replaced by organic ions, whereby their chemical and physical properties can change.

Preferred structured silicates in the context of the present invention are montmorillonite, bentonite, hectorite, kaolinite, serpentine, talc, pyrophyllite, mica, phlogopite, biotite, muscovite, paragonite, vermiculite, beidellite, xantophyllite, margarite, feldspar, zeolite, wollastonite, actinolite, amosite, crocidolite, sillimanite, nontronite, smectite, sepiolite, saponite, faujasite, permutite and sasil. Examples of naturally occurring structured silicates are described in WO 01/40878 A1.

The ionic structured silicate can be either of natural origin, e.g. contained in or alongside a naturally occurring mineral or rock, such as, for example, bentonite or montmorillonite, or a synthetically prepared structured silicate, e.g. a magnesium hydrosilicate or a synthetic hectorite or Na₂[Si₂O₅].

In the case of a naturally occurring structured silicate, the geographical deposit can have an influence on the chemical and physical properties of the material. Ionic structured silicates, which in nature are often accompanied by other minerals or rocks (e.g. quartz), can be processed by mechanical or chemical process steps, for example very finely ground, purified or separated from other concomitant substances, pH-treated, dehydrated, pressure-treated, heat-treated, treated oxidatively or reductively or with chemical auxiliaries.

In the context of the present invention, low molecular weight organic cations are understood as meaning non-polymeric organic cations from the group consisting of substituted ammonium, phosphonium, thionium, triphenylcarbonium ions or cationic metal complexes.

Low molecular weight, i.e. non-polymeric, ammonium ions of the formulae (a)-(j) are preferred:

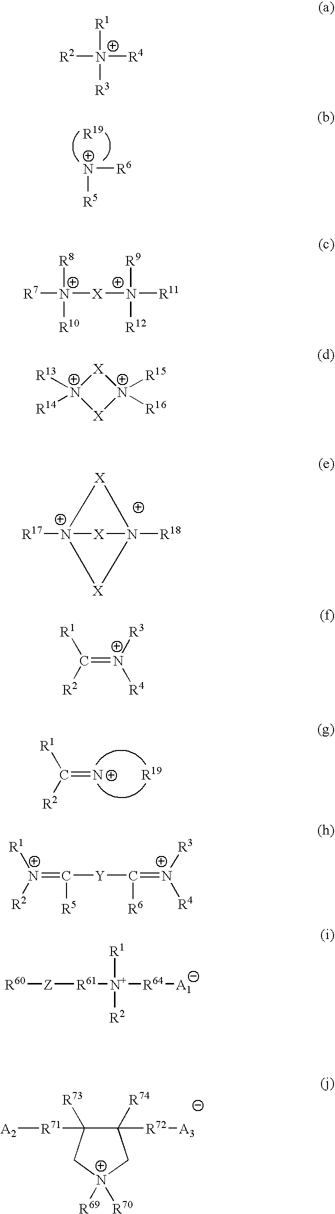

wherein

R¹ to R¹⁸ are identical or different and represent hydrogen, CN, (CH₂)₁₋₁₈CN, halogen, e.g. F, Cl or Br, branched or unbranched C₁-C₃₂-alkyl, mono- or polyunsaturated C₂-C₃₂-alkenyl, in particular C₂-C₂₂-alkenyl, such as e.g. tallow fatty alkyl; C₁-C₂₂-alkoxy, C₁-C₂₂-hydroxyalkyl, C₁-C₂₂-haloalkyl, C₂-C₂₂-haloalkenyl, C₁-C₂₂-aminoalkyl, (C₁-C₁₂)-trialkyl-ammonium-(C₁-C₂₂)-alkyl; (C₁-C₂₂)-alkylene-(C═O)O—(C₁-C₃₂)alkyl, (C₁-C₂₂)-alkylene-(C═O)O-aryl, (C₁-C₂₂)-alkylene-(C═O)NH-(C₁-C₃₂)alkyl, (C₁-C₂₂)-alkylene-(C═O)NH-aryl, (C₁-C₂₂)-alkylene-O(C═O)-(C₁-C₃₂)alkyl, in particular (C₁-C₁₈)alkylene-O(CO)-(C₁-C₃₂)alkyl, (C₁-C₂₂)-alkylene-O(CO)aryl, (C₁-C₂₂)alkylene-NH(C=O)-(C₁-C₃₂)alkyl, (C₁-C₂₂)-alkylene-NHCO-aryl, wherein

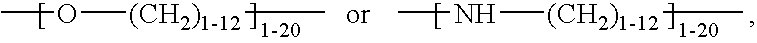

can be inserted into the acid ester or acid amide bonds;

[(C₁-C₁₂)-alkylene-O—]₁₋₁₀₀-H; aryl, (C₁-C₁₈)-alkylenearyl, —(O-SiR′₂)₁₋₃₂—O—SiR′₃, wherein R′ has the meaning C₁-C₁₂-alkyl, phenyl, benzyl or C₁-C₁₂-alkoxy; heterocyclyl, C₁-C₁₈-alkylene-heterocyclyl;

R¹⁹ represents C₄-C₁₁-alkylene, —(C₂H₄—O—)₁₋₁₇—(CH₂)₁₋₂—, —(C₂H₄—NR—)₁₋₁₇—(CH₂)₁₋₂—, wherein R is hydrogen or C₁-C₁₂-alkyl;

X has the meaning of Y and —CO—CH₂—CO—,

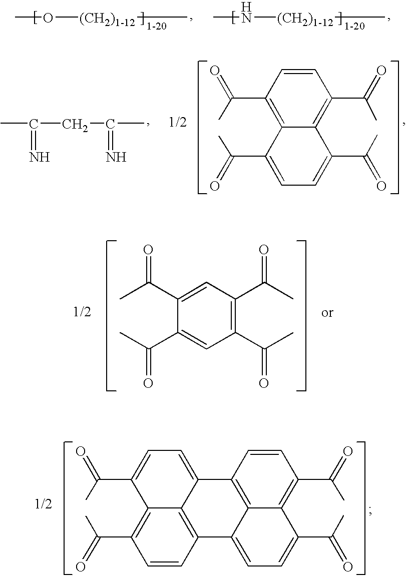

Y has the meaning

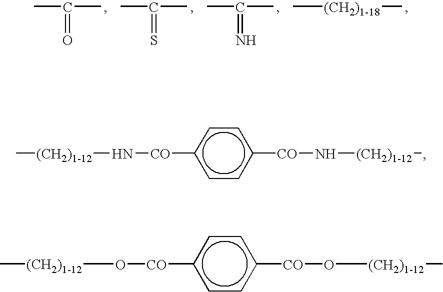

or o-, p-, m-(C₆-C₁₄)-arylene or (C₄-C₁₄)-heteroarylene with 1, 2, 3 or 4 heteroatoms from the group consisting of N, O and/or S;

R⁶⁰ represents C₁-C₃₂-acyl, C₁-C₂₂-alkyl, C₂-C₂₂-alkenyl, C₁-C,8-alkylene-C₆-C₁₀-aryl, C₁-C₂₂-alkylene-heterocyclyl, C₆-C₁₀-aryl or (C₄-C₁₄)-heteroaryl with 1, 2, 3 or 4 heteroatoms from the group consisting of N, O and/or S,

R⁶¹ and R⁶⁴ represent —(CH₂)₁₋₁₈—, C₁-C₁₂-alkylene-C₆-C₁₀-arylene, C₆-C₁₀-arylene, C₀-C₁₂-alkylene-heterocyclyl;

Z represents —NH— or —O—;

A₁^{Θ} and A₃^{Θ} represent —COO^{Θ}, —SO₃^{Θ}, —OSO₃^{Θ}, —SO₂^{Θ}, —COS^{Θ} or —CS₂^{Θ};

A₂ represents —SO₂Na, —SO₃Na, —SO₂H, —SO₃H or hydrogen;

R⁶⁹ and R⁷⁰ independently of one another represent hydrogen, C₁-C₃₂-alkyl, wherein the alkyl chain can contain one or more of the groups —NH—CO—, —CO—NH—, —CO—O— or —O—CO—; C₁-C₁₈-alkylene-aryl, C₀-C₁₈-alkylene-heterocyclyl, C₁-C₁₈-hydroxyalkyl, C₁-C₁₈-haloalkyl, aryl, —(CH₂)₃—SO₃^{Θ},

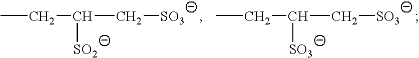

R⁷¹ and R⁷² represent —(CH₂)₁₋₁₂—; and

R⁷³ and R⁷⁴ represent hydrogen or C₁-C₂₂-alkyl.

Unless described otherwise, in the definitions above and below “aryl” preferably represents C₆-C₁₈-aryl, in particular phenyl or naphthyl, “heterocyclyl” preferably represents a saturated, unsaturated or aromatic, five- to seven-membered ring with 1, 2, 3 or 4 heteroatoms from the group consisting of N, O and/or S, for example pyridyl, imidazolyl, triazinyl, pyridazyl, pyrimidinyl, pyrazinyl, piperidinyl, morpholinyl, purinyl, tetrazonyl, pyrrolyl. The aryl and heterocyclyl radicals can furthermore be substituted on carbon atoms or heteroatoms once or several times, e.g. 2, 3, 4 or 5 times, by C₁-C₁₂-alkyl, C₁-C₄-alkenyl, C₁-C₄-alkoxy, hydroxy-(C₁-C₄)alkyl, amino-(C₁-C₄)alkyl, C₁-C₄-alkylimino, carboxyl, hydroxyl, amino, nitro, cyano, halogen, C₁-C₁₂-acyl, C₁-C₄-haloalkyl, C₁-C₄-alkylcarbonyl, C₁-C₄-alkylcarbonyloxy, C₁-C₄-alkoxycarbonyl, C₁-C₄-alkylaminocarbonyl, C₁-C₄-alkylcarbonylimino, C₆-C₁₀-arylcarbonyl, aminocarbonyl, aminosulfonyl, C₁-C₄-alkylaminosulfonyl, phenyl, naphthyl, heteroaryl, e.g. pyridyl, imidazolyl, triazinyl, pyrimidinyl.

Preferred heterocyclic ammonium ions are furthermore aliphatic or aromatic, 5 to 12-membered heterocyclyls with 1, 2, 3 or 4 N—, O— or/and S atoms belonging to the ring, it being possible for 2 to 8 rings to be fused, in particular pyridinium, pyridazinium, pyrimidinium, pyrazinium, purinium, tetraazaporphyrinium, piperidinium, morpholinium, tetrazonium.

Further suitable heterocyclyls are e.g. pyrrolium, pyrazolium, imidazolium, benzimidazolium, imidazolonium, benzimidazolonium, imidazolinium, benzimidazolinium, alkylpyrrolidino-benzimidazolonium, indolium, isoindolium, indolizinium, pyrrolizidinium, carbazolium, indazolium, quinolinium, isoquinolinium, pyrindenium, acridinium, phenanthridinium, lilolinium, julolinium, natridinium, cinnolinium, quinazolinium, quinoxalinium, perimidinium, phenazonium, phenazinium, 1,10-phenanthrolinium, β-carbolinium, quinolizinium, 1,8-naphthyidrinium, pteridinium, quinuclidinium, conidinium, hypoxanthinium, adeninium, xanthinium, isoxanthinium, heteroxanthinium, isoadeninium, guaninium, epiguaninium, theophyllinium, paraxanthinium, theobrominium, caffeinium, isocaffeinium, trihydroxypurinium, porphyrinium, tetraazaphorphyrinium, metal-complexed tetraazaphorphyrinium (e.g. with Mg, Ca, Sr, Ba, Al, Mn, Fe, Co, Cu, Zr, Ti, Cr, Ni, Zn),

bis-tetrazonium, phenoxazinium, aminoxanthenium, and derivatives of the cations mentioned mono- or polysubstituted on C or heteroatoms, wherein the substituents independently of one another can be carboxyl, hydroxyl, C₁-C₂₂-alkoxy, C₁-C₃₂-alkyl, in particular C₁-C₂₂-alkyl, C₂-C₂₂-alkenyl, hydroxy-(C₁-C₂₂)-alkyl, amino, aminoalkyl, C₁-C₁₈-iminoalkyl, alkylamido, alkylcarbonyloxy, alkyloxycarbonyl, (C₁-C₂₂)-alkylene-(C═O)O—(C₁-C₃₂)alkyl, (C₁-C₂₂)-alkylene-(C═O)O-aryl, (C₁-C₂₂)alkylene-(C═O)NH-(C₁-C₃₂)alkyl, (C₁-C₂₂)-alkylene-(C═O)NH-aryl, (C₁-C₂₂)-alkylene-O(CO)-(C₁-C₃₂)alkyl, (C₁-C₂₂)alkylene-O(CO)-aryl, (C₁-C₂₂)alkyleneNH(C═O)-(C₁-C₃₂)alkyl, (C₁-C₂₂)-alkylene-NHCO-aryl; wherein

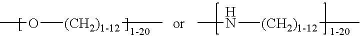

can be inserted into the acid ester or acid amide bonds;

nitro, cyano, halogen, poly(C₁-C₁₂-alkylene oxide) or C₁-C₂₂-acyl, in particular N— or C-(C₁-C₂₂)-alkylated heterocyclyls, as mentioned above, e.g. N-(C₁-C₂₀)alkyl-pyridinium or 1-methyl-1-stearylamidoethyl-2-stearyl-imidazolinium.

Ions of the formulae (a)-(j) which are of particular interest are those wherein. R¹ to R¹⁸ are hydrogen, CN, CH₂—CN, CF₃, C₁-C₂₂-alkyl, e.g. coconut alkyl, cetyl, stearyl or hydrogenated tallow fatty alkyl; C₂-C₂₂-alkenyl, in particular C₂-C₁₈-alkenyl, C₁-C₁₈-alkoxy, C₁-C₁₈-hydroxy-alkyl, C₁-C₁₈-haloalkyl, C₂-C₁₈-haloalkenyl, wherein halo is preferably F or Cl, C₁-C₁₈-aminoalkyl, (C₁-C₆)-trialkylammonium-(C₁-C₁₈)-alkyl, (C₁-C₁₈)-alkylene-O(C═O)—(C₁-C₂₂)alkyl, (C₁-C₁₈)-alkylene-O(C═O)-phenyl, (C₁-C₁₈)-alkylene-NHCO-(C₁-C₂₂)alkyl, (C₁-C₁₈)-alkylene-NHCO-phenyl, (C₁-C₁₈)-alkylene-(C═O)O-(C₁-C₂₂)alkyl, (C₁-C₁₈)-alkylene-(C═O)O-phenyl, (C₁-C₁₈)alkylene-(C═O)NH-(C₁-C₂₂)alkyl, (C₁-C₁₈)-alkylene-CONH-phenyl, benzyl, phenyl, naphthyl, C₁-C₁₂-alkylene-heterocyclyl;

R¹⁹ is C₄-C₅-alkylene, —(C₂H₄—O)₁₋₉-(CH₂)₁₋₂—, —(C₂H₄—NH)₁₋₉—(CH₂)₁₋₂—;

R⁶⁰ is C₁-C₁₈-acyl, C₁-C₁₈-alkyl, C₂-C₁₈-alkenyl, C₁-C₁₂-alkylene-phenyl, C₁-C₁₈-alkylene-pyridyl, phenyl, pyridyl;

R⁶¹ and R⁶⁴ are —(CH₂)₁₋₁₂—, C₁-C₈-alkylene-phenylene, phenylene; C₁-C₈-alkylenepyridylene- or -piperidylene;

R⁷¹ and R⁷² are —(CH₂)₁₋₈ and

R⁷³ and R⁷⁴ are hydrogen or (C₁-C₁₈)-alkyl.

Preferred low molecular weight organic cations are furthermore cationic metal complexes, such as metal carboxylates, metal salicylates, metal sulfonates, 1:1 metal-azo complexes or metal dithiocarbamates, wherein metal is preferably Al, Mg, Ca, Sr, Ba, TiO, VO, Cr, V, Ti, Zr,. Sc, Mn, Fe, Co, Ni, Cu, Zn and ZrO, and the metal complex optionally contains one or more further ligands.

Preferred metal carboxylates and salicylates are those of the formulae (k) and (I)

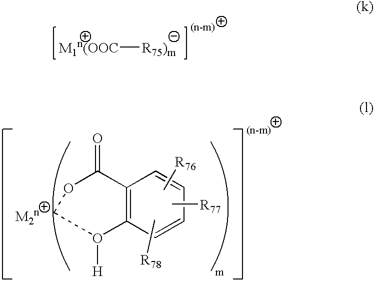

wherein n=2, 3 or 4;

m=1, 2 or 3, but is always less than n;

M₁^{n⊕} and and M₂^{n⊕} independently of one another are a metal cation from the main group or transition metals, for example are B, Al, Mg, Ca, Sr, Ba, Sc, V, Ti, Zr, TiO, Cr, Mn, Fe, Co, Ni, Cu, Zn, ZrO,

R₇₅ can be C₁-C₃₂-alkyl (linear or branched), C₁-C₂₂-haloalkyl, C₁-C₁₈-hydroxyalkyl, C₁-C₁₈-aminoalkyl, C₁-C₁₈-ammoniumalkyl, C₁-C₁₈-alkylene-aryl, C₁-C₁₈-alkylene-heterocyclyl, aryl, heterocyclyl, as defined above;

R₇₆ to R₇₈ independently of one another can be C₁-C₁₂-alkyl (linear or branched), C₁-C₄-alkoxy, hydroxyl, carboxyl, C₁-C₄-alkenyl, hydroxy-(C₁-C₄)-alkyl, amino, (C₁-C₄)-aminoalkyl, nitro, cyano, halogen, C₁-C₁₂-acyl, C₁-C₄-iminoalkyl, C₁-C₄-haloalkyl, aryl or heterocyclyl, as defined above.

Analogous cationic complexes or salts of the abovementioned metals with ligands, such as α-hydroxyphenyl, α-aminoaniline, α-hydroxyaniline, α-aminobenzoic acid, quinoline, 1,8-diaminonaphthalene, 1,4,5,8-tetraaminonaphthalene, 1,8-dihydroxynaphthalene or 1,4,5,8-tetrahydroxynaphthalene, are furthermore suitable.

Analogous cationic complexes or salts of the abovementioned metals with ligands or anions, such as, for example, α,α-dipyridyl, ethylenediamine, diethylenetriamine, triethylenetetraamine, acetylacetonate, ortho-phenanthroline, benzoyl ketones, ethylenedi(biguanidine), biguanidine or dimethylglyoxime, are furthermore suitable.

Triphenylmethane cations of the formula

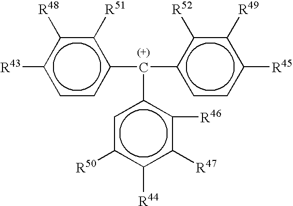

wherein

R⁴³ and R⁴⁵ are identical or different and are —NH₂, a mono- and dialkylamino group, the alkyl groups of which have 1 to 4, preferably 1 or 2 carbon atoms, a mono- or di-omega-hydroxyalkylamino group, the alkyl groups of which have 2 to 4, preferably 2 carbon atoms, an optionally N-(C₁-C₄)alkyl-substituted phenyl or phenalkylamino groups, the alkyl of which has 1 to 4, preferably 1 or 2 carbon atoms and the phenyl nucleus of which can carry one or two of the radicals methyl, ethyl, methoxy, ethoxy, sulfo,

R⁴⁴ is hydrogen or has one of the meanings mentioned for R⁴³ and R⁴⁵,

R⁴⁶ and R⁴⁷ are hydrogen, halogen, preferably chlorine, or a sulfonic acid group or

R⁴⁶ with R⁴⁷ together form a fused-on phenyl ring,

R⁴⁸, R⁴⁹, R⁵¹ and R⁵² each are hydrogen or an alkyl radical having 1 or 2 carbon atoms, preferably methyl, and

R⁵⁰ is hydrogen or halogen, preferably chlorine, are furthermore suitable.

In the context of the present invention, possible waxes are acid waxes, for example montan acid waxes or partly esterified or partly saponified montan acid waxes, ester waxes, for example hydroxystearic acid ester waxes, montan acid ester waxes or partly hydrolyzed montan acid ester waxes, amide waxes, for example C₁₈-C₄₄-fatty acid amide waxes, carnauba waxes, polyolefin waxes, for example polyethylene or polypropylene waxes, polyolefin degradation waxes, oxidized PE, PP or paraffin waxes, PP waxes modified by grafting with further monomers, such as, for example, silanes, acrylic acid derivatives, methacrylic acid derivatives, maleic anhydride or styrene, polyolefin-metallocene waxes and paraffin waxes.

A characteristic of said waxes is a relatively sharp melting or drop point of 40-200° C., above the drop point a relatively low-viscosity consistency with viscosities in a range of 5-5,000 mPas, a coarsely to finely crystalline structure, a molecular weight of 250-20,000 g/mol (number-average Mn), polishability under gentle pressure, relatively low acid numbers of 0-200 mg of KOH/g, and an extremely low water-solubility, also above the drop or melting point and simultaneously alkaline pH conditions.

Possible metal soaps are compounds from the group consisting of mono-, di-, tri- or tetravalent metals salts of saturated or unsaturated C₇-C₄₃-carboxylic acids, C₈-C₄₄-sulfates, C₈-C₄₄-alkyl ether-sulfates, C₈-C₄₄-alkylamido ether-sulfates, C₈-C₄₄-alkylsulfonates, C₈-C₄₄-aralkylsulfonates (wherein aryl denotes C₆-C₁₂ and alkyl denotes C₁-C₃₂), C₈-C₄₄-alkyl ether-sulfosuccinates, C₈-C₄₄-acylglutamates, C₈-C₄₄-fatty acid isethionates, C₈-C₄₄-fatty acid methyltaurides, C₈-C₄₄-fatty acid sarcosides, C₈-C₄₄-phosphates, acid waxes, partly esterified acid waxes, partly hydrolyzed ester waxes or oxidized PE or paraffin waxes, in particular Li, Na, K, Al, Ba, Sr, Ca, Fe, Co, Cu, Mg, Mn, Ni, Pb, ZrO, TiO and Zn stearates, behenates, erucates, palmitates, oleates, linoleates, resinates, laurates, myristates, naphthenates, tallates, dodecylsulfates, lauryl diglycol ether-sulfates, lauryl triglycol ether-sulfates, secondary C₁₀-C₁₈-alkylsulfonates, dodecylbenzenesulfonates, coconut alkylamido-polyglycol ether-sulfates, coconut alkyl polyglycol ether-sulfosuccinates, N-cocoylglutamates, coconut fatty acid isethionates, coconut fatty acid methyltaurides and lauric acid sarcosides.

The invention also provides a process for the preparation of the hydrophobic salt-like structured silicates, as described.

The salt-like structured silicates can be prepared according to (a) by bringing together one or more natural or synthetic structured silicates with the salts containing the low molecular weight organic cations, e.g. the corresponding chlorides, bromides, iodides, methyl-sulfates, in aqueous suspension, which can contain a content of e.g. up to 30 wt. % of an organic solvent, in a weight ratio of organic cations : silicate of from 1:100 to 10:1, preferably from 1:20 to 3: 1, e.g. at a temperature of from 5 to 160° C., in one or in several steps.

It is advantageous to predisperse the structured silicate in water for between ½ and 48 hours, preferably between 1 and 24 hours. It is furthermore advantageous to adjust the salt of the organic cation and/or the aqueous suspension of the structured silicate to a pH of between 1 and 12, preferably 3 and 11, before the reaction in the aqueous medium.

The hydrophobic compound can already be added before the start of carrying out step (a) and/or can be added during carrying out of step (a) and/or can be added after step (a) has ended.

Preferably, the hydrophobic compound is dissolved in an organic solvent and is added as a solution at a temperature of between 20 to 200° C., or the hydrophobic compound is added as an aqueous dispersion or solution at a temperature of between 20 and 200° C. Here also, the aqueous dispersions can contain contents (up to 40 wt. %) of organic solvent, e.g. alcohol.

It is also possible to meter in the hydrophobic compound as a powder or slowly in molten form, for example in a fine jet in the course of at least 1 minute, expediently at a temperature of between 20 and 200° C.

The hydrophobic compound is added with intensive thorough mixing with the aqueous dispersion of the structured silicate, for example with intensive stirring with suitable stirring units, such as an Ultraturrax of propeller stirrer, a bead mill, or also with the aid of ultrasound.

For use of the hydrophobic compound in dispersion or solution, it is expedient to use one or more anionic, cationic, zwitter-ionic or nonionic low molecular weight or polymeric dispersing auxiliaries, such as, for example, diethylaminoethanol (DEAE), alkylamines, alkyl-sulfates, alkylsulfonates, alkyl phosphates, betaines, sulfobetaines, poly(vinyl alcohol-co-vinyl acetate-co-vinylacetal) in the most diverse monomer composition, poly(styrene-co-acrylic acid), saturated or unsaturated fatty acids, alkyl or alkenyl poly(glycol ether), fatty alcohol poly(glycol ether) or fatty alcohol poly(glycol ether-block-propylene glycol ether), nonionic and cationic dispersing auxiliaries being preferred.

The content of dispersing auxiliary or auxiliaries in a dispersion or solution of the hydrophobic compound can be 0.1 to 500 wt. %, preferably 0.1 to 50 wt. %, based on the amount of hydrophobic compound.

The average particle size (d₅₀ value) in the dispersion of the hydrophobic compound is below 500 μm, preferably below 1 μm, particularly preferably below 500 nm.

If di- to tetravalent metal soaps are used, these are preferably prepared by precipitation immediately before the addition to the structured silicates, or are produced by precipitation in the reaction mixture only after addition to the structured silicates. In this procedure, the acid component, e.g. stearic acid, is dissolved in water, a water-solvent mixture or the reaction mixture, under the influence of heat, optionally also above the melting point of this component, and with the addition of alkali, such as, for example, solid or aqueous sodium hydroxide, and optionally one or more of the dispersing auxiliaries described above, and precipitation is then carried out by addition of an aqueous solution of a di- to tetravalent metal salt, such as, for example, a zinc sulfate, zinc chloride, zinc hydroxide, aluminum chloride, aluminum sulfate, aluminum hydroxide or zirconyl chloride solution. In this context, the molar ratio of the charges of the metal cation of higher valency to those of the acid groups of the acid component of the metal soaps can be between 1:100 to 10:1, preferably between 1:50 and 5:1, in particular between 1:10 and 3:1.

When all the components have been combined and, if appropriate, the pH has been adjusted to a value of between 2 and 11, preferably 2 and 10, the reaction mixture is expediently separated off from the liquid phase over a filter, optionally under pressure and still in the heated state, washed free from impurities with deionized water or a water-solvent mixture, for example a water-alcohol mixture, the washing operation being controlled by means of the conductivity and a conductivity of the filtrate of <10 mS/cm, preferably <1 mS/cm, being aimed for, and the product is then dried, for example by means of circulating air drying, vacuum drying, spin flush drying, spray drying or fluidized bed drying, and optionally ground to a powder.

The invention furthermore provides the use of the hydrophobic salt-like structured silicate according to the invention as a charge controlling agent in electrophotographic toners and developers, powder coatings, electret materials, electronic ink (e-ink), electronic paper (e-paper) and in electrostatic separation operations, and as an additive for improving or controlling the flowability of the toner powder, and as an anti-offset agent.

In this context, the structured silicates according to the invention, individually or in combination with one another or with further components mentioned below, are incorporated homogeneously, for example by extrusion or kneading in, bead mills or with an Ultraturrax (high-speed stirrer), in a concentration of from 0.01 to 50 wt. %, preferably from 0.05 to 20 wt. %, particularly preferably from 0.1 to 5.0 wt. %, based on the total mixture, into the binder of the particular toner, developer, lacquer, powder coating, electret material or of the polymer to be separated electrostatically. In this context, the compounds employed according to the invention can be added as dried and ground powders, colloidal solutions, press-cakes, masterbatches, preparations, mixed pastes, as compounds absorbed from aqueous or non-aqueous dispersion on to suitable carriers, such as e.g. silica gel, or mixed with such carriers, TiO₂, Al₂O₃, carbon black. The compounds used according to the invention can likewise in principle also already be added during the preparation of the particular binders, i.e. in the course of the polymerization, polyaddition or polycondensation thereof, and during the preparation of polymerization toners, for example during the suspension, emulsion polymerization or during the aggregation of the polymer systems to toner particles. The charge controlling agent particles which are present after the dispersing in the binder should be smaller than 1 μm, preferably smaller than 0.5 μm, a narrow particle size distribution being advantageous.

The charge controlling agents according to the invention can also be employed in the form of finely divided, aqueous, aqueous-organic or organic dispersions. The particle sizes (d₅₀ values) are between 20 nm and 1 μm, preferably between 50 and 500 nm. Concentrations of charge controlling agent of between 0.01 and 50 wt. %, preferably between 0.1 and 30 wt. %, based on the total weight of the dispersion, are expedient.

In the case of aqueous or aqueous-organic dispersions, water is preferably employed in the form of distilled or desalinated water.

In the case of organic or aqueous-organic dispersions, one or more organic solvents are employed as the organic medium, preferably from the group consisting of mono- or polyhydric alcohols, ethers and esters thereof, e.g. alkanols, in particular having 1 to 4 carbon atoms, such as e.g. methanol, ethanol, propanol, isopropanol, butanol, isobutanol; di- or trihydric alcohols, in particular having 2 to 6 carbon atoms, e.g. ethylene glycol, propylene glycol, 1,3-propanediol, 1,4-butanediol, 1,5-pentanediol, 1,6-hexanediol, 1,2,6-hexanetriol, glycerol, diethylene glycol, dipropylene glycol, triethylene glycol, polyethylene glycol, tripropylene glycol, polypropylene glycol; lower alkyl ethers of polyhydric alcohols, such as e.g. ethylene glycol monomethyl or ethyl or butyl ether, triethylene glycol monomethyl or ethyl ether; ketones and ketone alcohols, such as e.g. acetone, methyl ethyl ketone, di-ethyl ketone, methyl isobutyl ketone, methyl pentyl ketone, cyclopentanone, cyclohexanone, diacetone alcohol; amides, such as e.g. dimethylformamide, dimethylacetamide and N-methylpyrrolidone. Conventional ionic or nonionic low molecular weight or polymeric dispersing auxiliaries, such as e.g. sulfates, sulfonates, phosphates, polyphosphates, carbonates, carboxylates, carboxylic acids, silicates, hydroxides, metal soaps, polymers, such as acrylates, fatty acid derivatives and glycoside compounds, can additionally also be employed for the preparation of stable dispersions. The dispersions can furthermore contain metal-complexing agents, such as e.g. EDTA or NTA. The dispersions can furthermore also contain conventional additives, such as, for example, preservatives, biocides, antioxidants, degassing agents/defoamers and agents for regulating the viscosity, e.g. polyvinyl alcohol, cellulose derivatives or water-soluble natural or synthetic resins and polymers as film-forming agents or binders to increase the adhesive strength and abrasion resistance. Organic or inorganic bases and acids are employed as pH regulators. Preferred organic bases are amines, such as e.g. ethanolamine, diethanolamine, triethanolamine, diethylaminoethanol (DEAE), N,N-dimethyl-ethanolamine, diisopropylamine, aminomethylpropanol or dimethylminomethylpropanol. Preferred inorganic bases are sodium hydroxide, potassium hydroxide, lithium hydroxide or ammonia. Further constituents can be hydrotropic compounds, such as e.g. formamide, urea, tetramethylurea, ε-caprolactam, ethylene glycol, diethylene glycol, triethylene glycol, polyethylene glycol, butyl glycol, methylcellosove, glycerol, sugar, N-methylpyrrolidone, 1,3-diethyl-2-imidazolidinone, thiodiglycol, sodium benzenesulfonate, Na xylenesulfonate, Na toluenesulfonate, Na cumenesulfonate, Na benzoate, Na salicylate or Na butyl monoglycol-sulfate.

The charge controlling agents employed according to the invention can also be combined with already known positively or negatively controlling charge controlling agents in order to achieve particular chargings, the total concentration of the charge controlling agents expediently being between 0.01 and 50 wt. %, preferably between 0.05 and 20 wt. %, particularly preferably between 0.1 and 5 wt. %, based on the total weight of the electrophotographic toner, developer, powder or powder coating.

Possible further charge controlling agents are, for example:

triphenylmethanes; ammonium and immonium compounds, iminium compounds; fluorinated ammonium and fluorinated immonium compounds; bis-cationic acid amides; polymeric ammonium compounds; diallylammonium compounds; aryl sulfide derivatives, phenol derivative; phosphonium compounds and fluorinated phosphonium compounds; calix(n)arenes, cyclically linked oligosaccharides (cyclodextrins) and derivatives thereof, in particular boron ester derivatives, inter-polyelectrolyte complexes (IPECs); polyester salts; metal complex compounds, in particular salicylate-metal complexes and salicylate-nonmetal complexes, hydroxycarboxylic acid-metal complexes and hydroxycarboxylic acid non-metal complexes, benzimidazolones; azines, thiazines or oxazines which are listed in the Colour Index as pigments, solvent dyes, basic dyes or acid dyes, and highly disperse metal oxides, such as e.g. SiO₂, TiO₂ or Al₂O₃, which can be surface-modified, for example with carboxylate, amino, ammonium groups.

Examples of known charge controlling agents are listed in WO 01/40878 A1.

In order to prepare electrophotographic colored toners, also as a color toner set of two or more of the colors black, cyan, yellow, magenta, green, orange, red and blue, coloring agents, such as organic colored pigments, inorganic pigments or dyestuffs, conventionally in the form of powders, dispersions, press-cakes, solutions or masterbatches, are added.

The organic colored pigments can be from the group consisting of azo pigments or polycyclic pigments or mixed crystals (solid solutions) of such pigments.

Preferred blue and/or green pigments are copper phthalocyanines, such as C.I. Pigment Blue 15, 15:1, 15:2, 15:3, 15:4, 15:6, P. Blue 16 (metal-free phthalocyanine), or phthalocyanines with aluminum, nickel, iron or vanadium as the central atom, furthermore triarylcarbonium pigments, such as Pigment Blue 1, 2, 9, 10, 14, 60, 62, 68, 80, Pigment Green 1, 4, 7, 45; orange pigments, such as e.g. P.O. 5, 62, 36, 34, 13, 43, 71; yellow pigments, such as e.g. P.Y. 12, 13, 14, 17, 74, 83, 93, 97, 111, 122, 139, 151, 155, 180, 174, 175, 185, 188, 191, 213, 214, red pigments, such as e.g. P.R. 48, 57, 122, 146, 147, 149, 150, 184, 185, 186, 202, 207, 209, 238, 254, 255, 269, 270, 272, violet pigments, such as P.V. 1, 19, carbon black, iron/manganese oxides; furthermore mixed crystals of C.I. Pigment Violet 19 and C.I. Pigment Red 122.

Mixtures with organic dyestuffs are suitable in particular for increasing the brilliance, but also for adjusting the color shade. Such dyestuffs which are preferably to be mentioned are:

water-soluble dyestuffs, such as e.g. direct, reactive and acid dyes, and solvent-soluble dyestuffs, such as e.g. solvent dyes, disperse dyes and vat dyes. Examples which may be mentioned are: C.I. Reactive Yellow 37, Acid Yellow 23, Reactive Red 23, 180, Acid Red 52, Reactive Blue 19, 21, Acid Blue 9, Direct Blue 199, Solvent Yellow 14, 16, 25, 56, 62, 64, 79, 81, 82, 83, 83:1, 93, 98, 133, 162, 174, Solvent Red 8, 19, 24, 49, 89, 90, 91, 92, 109, 118, 119, 122, 124, 127, 135, 160, 195, 212, 215, Solvent Blue 44, 45, Solvent Orange 41, 60, 63, Disperse Yellow 64, Vat Red 41, Solvent Black 45, 27.

The electrophotographic toners and powder coatings according to the invention can of course also comprise further added waxes, as mentioned above, for example as anti-offset agents.

The compounds according to the invention can be added individually or in combination with free-flow agents, such as e.g. highly disperse silicas, metal oxides or metal soaps, also as external additives, to finished powder toners to improve the flow, to improve the adhesion properties and for electrostatic fine adjustment.

The present invention also provides an electrophotographic toner, powder or powder coating comprising 30 to 99.99 wt. %, preferably 40 to 99.5 wt. % of a conventional binder, for example a styrene, styrene acrylate, styrene-butadiene, acrylate, urethane, acrylic, polyester or epoxy resin or a combination of the last two, 0.01 to 50 wt. %, preferably 0.05 to 20 wt. %, particularly preferably 0.1 to 5 wt. % of at least one hydrophobic salt-like structured silicate and optionally 0.001 to 50 wt. %, preferably 0.05 to 20 wt. % of a coloring agent, in each case based on the total weight of the electrophotographic toner, powder or powder coating.

In the following examples, percent is percent by weight.

### PREPARATION EXAMPLE 1

25 g of bentonite (pH 7-12) are dispersed in 500 ml of deionized water for 12 hours at 20° C. by means of stirring. The suspension is then adjusted to a pH of between 4 and 10 by means of dilute sulfuric acid and thereafter 10 g of a 77% strength aqueous distearyidimethylammonium chloride solution (DSDMAC) are added to the bentonite suspension, and the reaction mixture is stirred at 60° C. for 1 hour. After a reaction time of 1 hour, a mixture of 7 g of a 77% strength aqueous DSDMAC solution and 50 g of a 10% strength aqueous montan acid ester wax dispersion, which has been prepared by addition of 10 g of molten montan acid ester wax (®Licowax F, Clariant, acid number 6-10 mg of KOH/g, drop point 75-81° C.) into an approx. 95° C. hot aqueous solution comprising 0.7 g of 21% strength KOH-ethylene glycol solution, 3 g of 10% strength polyvinyl alcohol solution (®Mowiol 4-88, Kuraray, Germany) and 86.3 g of deionized water, are added.

The reaction mixture is then stirred again for 1 hour at 60° C., and the solid is filtered off with suction, rinsed several times with deionized water and then dried at 60° C. in vacuo.

Yield: 39.8 g of white-grey powder.

Characterization:

| | |
|---|---|
| Appearance: | white to pale grey powder |
| DTA: | no detectable decomposition up to 400° C. |
| pH: | 7.6 |
| Conductivity: | 0.18 mS/cm |
| Residual moisture: | 1.0% (Karl Fischer titration) |
| tan δ (1 kHz): | 0.6 |
| Ω cm: | 3 · 10¹⁰ |
| Solubilities: | insoluble in water, ethanol, acetone, |
| | n-hexane (<10 mg/l). |

### PREPARATION EXAMPLE 2

25 g of bentonite (pH 7-12) are dispersed in 500 ml of deionized water for 12 hours at 20° C. by means of stirring. The suspension is then adjusted to a pH of between 4 and 10 by means of dilute sulfuric acid and thereafter 17 g of a 77% strength aqueous distearyidimethylammonium chloride solution (DSDMAC) are added in two parts to the bentonite suspension, and the reaction mixture is stirred at 80° C. for 1 hour. After a reaction time of 1 hour, 50 g of a 10% strength isopropanolic wax solution which contains a wax mixture of 75% of erucic acid amide wax and 25% of carnauba wax are added.

The reaction mixture is then stirred again for 1 hour at 80° C., and the solid is filtered off with suction, rinsed several times with deionized water and then dried at 60° C. in vacuo.

Yield: 38.9 g of ivory-colored powder.

Characterization:

| | |
|---|---|
| Appearance: | ivory-colored powder |
| DTA: | no decomposition up to 400° C. |
| pH: | 7.5 |
| Conductivity: | 0.18 mS/cm |
| Residual moisture: | 1.1% (Karl Fischer titration) |
| tan δ (1 kHz): | 0.8 |
| Ω cm: | 3 · 10¹⁰ |
| Particle size distribution: | d₅₀ = 9 μm, d₉₅ = 21 μm (laser light diffraction) |
| BET: | 24.9 m²/g |
| Solubilities: | insoluble in water, ethanol, acetone, |
| | n-hexane (<10 mg/l). |

### PREPARATION EXAMPLE 3

25 g of bentonite (pH 7-12) are dispersed in 500 ml of deionized water for 12 hours at 20° C. by means of stirring. The suspension is then adjusted to a pH of between 4 and 10 by means of dilute sulfuric acid, thereafter 17 g of a 77% strength aqueous distearyldimethylammonium chloride solution (DSDMAC) are added in two parts to the bentonite suspension, and the reaction mixture is stirred at 80° C. for 1 hour. After a reaction time of 1 hour, an aqueous aluminum stearate dispersion which has been prepared by dissolving 5 g of stearic acid, 95 g of deionized water, 1.8 g of sodium hydroxide lozenges, 8 g of iso-propanol and 0.5 g of coconut fatty alcohol polyglycol ether (®Genapol C 050, Clariant, Germany) at 80° C., subsequent precipitation at the same temperature with a solution of 2.3 g of Al₂(SO₄)₃·18H₂O in 50 g of deionized water and adjustment of the precipitated suspension to a pH of 3-12 is added.

The reaction mixture is then adjusted to a pH of 3-10, stirred again for 1 hour at 80° C., and the solid is filtered off with suction, rinsed several times with deionized water and then dried at 60° C. in vacuo.

Yield: 41.1 g of white-grey powder.

Characterization:

| | |
|---|---|
| Appearance: | white-grey powder |
| DTA: | no decomposition up to 400° C. |
| pH: | 6.6 |
| Conductivity: | 0.23 mS/cm |
| Residual moisture: | 1.2% (Karl Fischer titration) |
| tan δ (1 kHz): | 1.1 |
| Ω cm: | 8 · 10⁹ |
| Particle size distribution: | d₅₀ = 7 μm, d₉₅ = 19 μm (laser light diffraction) |
| BET: | 21.9 m²/g |
| Solubilities: | insoluble in water, ethanol, acetone, |
| | n-hexane (<10 mg/l) |

### PREPARATION EXAMPLE 4

25 g of bentonite (pH 7-12) are dispersed in 500 ml of deionized water for 12 hours at 20° C. by means of stirring. The suspension is then adjusted to a pH of between 4 and 10 by means of dilute sulfuric acid, thereafter 17 g of a 77% strength aqueous distearyldimethylammonium chloride solution (DSDMAC) are added in two parts to the bentonite suspension, and the reaction mixture is stirred at 60° C. for 1 hour. After a reaction time of 1 hour, 2.5 g of sodium dodecylsulfate are added as a powder or as an aqueous solution and the reaction mixture is stirred for a further hour at 60° C.

The reaction mixture is then adjusted to a pH of 3-10, and the solid is filtered off with suction, rinsed several times with deionized water and then dried at 60° C. in vacuo.

Yield: 37.1 g of white-grey powder.

Characterization:

| | |
|---|---|
| Appearance: | white-grey powder |
| DTA: | no decomposition up to 400° C. |
| pH: | 6.8 |
| Conductivity: | .28 mS/cm |
| Residual moisture: | 1.3% (Karl Fischer titration) |
| tan δ (1 kHz): | 0.9 |
| Ω cm: | 4 · 10¹⁰ |
| Particle size distribution: | d₅₀ = 7 μm, d₉₅ = 15 μm (laser light diffraction) |
| BET: | 22.6 m²/g |
| Solubilities: | insoluble in water, ethanol, acetone, |
| | n-hexane (<10 mg/l) |

### PREPARATION EXAMPLES 5 to 14

| | According | Structured | | Hydrophobic |
|---|---|---|---|---|
| No. | to Ex. | silicate used | Organic cation | compound |
| 5 | 2 | bentonite | DSDMAC | montan ester wax |
| | | | | (Licowax F, Clariant) |
| 6 | 3 | bentonite | DSDMAC | Zn stearic acid salt |
| 7 | 3 | bentonite | DSDMAC | ZrO stearic acid salt |
| 8 | 1 | bentonite | DSDMAC | montan acid wax |
| | | | | (Licowax S, Clariant) |
| 9 | 1 | bentonite | DSDMAC | oxid. PE wax |
| | | | | (Licowax PED192) |
| 10 | 1 | bentonite | didecyldimethylammonium | montan ester wax |
| | | | | (Licowax F, Clariant) |
| 11 | 2 | bentonite | triphenylmethane cation | montan ester wax |
| | | | | (Licowax F, Clariant) |
| 12 | 3 | bentonite | C₁₂/C₁₄-alkyldimethylbetaine | Al stearic acid salt |
| 13 | 2 | bentonite | cetylpyridinium | erucic acid amide |
| 14 | 3 | hectorite | DSDMAC | Zn stearic acid salt |

### USE EXAMPLE 1a

1 part of the compound from Preparation Example 1 is incorporated homogeneously into 99 parts of a polyester resin based on bisphenol A (®Fine Tone 382-ES) by means of a kneader in the course of 30 minutes. The mixture is subsequently ground on a laboratory universal mill and then graded on a centrifugal sifter. The desired particle fraction (4 to 25 μm) is activated at 25° C./40-60% rel. atmospheric humidity with a carrier which comprises silicone-coated ferrite particles 50 to 200 μm in size.

### USE EXAMPLE 1b

The procedure is as in Use Example 1a, the activation of the toner with the carrier being carried out after 24 hours of storage of the toner-carrier mixture at 25° C./90 % rel. atmospheric humidity.

The measurement is carried out on a conventional q/m measuring station. By using a sieve having a mesh width of 45 μm, it is ensured that no carrier is carried along when the toner is blown out. The following q/m values [μC/g] are measured according to the duration of the activation:

Use Example

| | |
|---|---|
| 1a | 1b |

| | |
|---|---|
| Duration of activation | charging q/m [μC/g] |

| | | |
|---|---|---|
| 5 min | −17 | −11 |
| 10 min | −18 | −12 |
| 30 min | −19 | — |
| 2 h | −19 | — |

### USE EXAMPLES 2 TO 19

The procedure is as in Use Example 1a or 1b, the compounds listed below being employed instead of the compound from Preparation Example 1.

| | Preparation | According | q/m [μC/g] | | | |
|---|---|---|---|---|---|---|
| Use Ex. | Example | to Use Ex. | 5 min | 10 min | 30 min | 2 h |
| 2 | 2 | 1a | −16 | −16 | −17 | −16 |
| 3 | 2 | 1b | −11 | −12 | — | — |
| 4 | 3 | 1a | −19 | −20 | −21 | −21 |
| 5 | 3 | 1b | −13 | −14 | — | — |
| 6 | 4 | 1a | −18 | −20 | −20 | −20 |
| 7 | 4 | 1b | −12 | −13 | — | — |
| 8 | 5 | 1a | −18 | −19 | −20 | −20 |
| 9 | 5 | 1b | −11 | −11 | — | — |
| 10 | 6 | 1a | −19 | −20 | −20 | −20 |
| 11 | 6 | 1b | −12 | −12 | — | — |
| 12 | 7 | 1a | −18 | −19 | −20 | −20 |
| 13 | 8 | 1a | −15 | −18 | −18 | −19 |
| 14 | 9 | 1a | −17 | −18 | −18 | −18 |
| 15 | 10 | 1a | −17 | −18 | −19 | −19 |
| 16 | 11 | 1a | −15 | −16 | −16 | −17 |
| 17 | 12 | 1a | −14 | −15 | −15 | −14 |
| 18 | 13 | 1a | −15 | −15 | −16 | −15 |
| 19 | 14 | 1a | −13 | −14 | −14 | −14 |

### USE EXAMPLES 20 TO 23

The procedure is as in Use Example 1a, 2 or 3 parts of the corresponding compound being employed instead of 1 part.

| Ex. | Preparation | | q/m [μC/g] | | | |
|---|---|---|---|---|---|---|
| No. | Ex. | Parts | 5 min | 10 min | 30 min | 2 h |
| 20 | 1 | 2 | −20 | −21 | −21 | −21 |
| 21 | 1 | 3 | −24 | −25 | −26 | −25 |
| 22 | 3 | 2 | −23 | −24 | −25 | −25 |
| 23 | 3 | 3 | −26 | −27 | −28 | −28 |

### USE EXAMPLES 24 TO 26

The procedure is as in Use Example 1a, 5 parts of an organic pigment (carbon black ®Mogul L, Cabot; ®Toner MagentaEO2, Clariant (C.I. P. Red 122); ®Toner Yellow HG, Clariant (C.I. P. Yellow 180)) additionally also being incorporated.

| | Organic | q/m [μC/g] | | | |
|---|---|---|---|---|---|
| No. | pigment | 5 min | 10 min | 30 min | 2 h |
| 24 | Toner Magenta EO2 | −18 | −19 | −20 | −20 |
| 25 | Toner Yellow HG | −17 | −18 | −18 | −18 |
| 26 | carbon black | −19 | −19 | −19 | −20 |

### USE EXAMPLES 27 AND 28

The procedure is as in Use Examples 1a and 3a, 2 parts of a coloring agent having an electrostatically positive intrinsic effect (C.I. Solvent Blue 125), also being incorporated in to the one part of the compound from Preparation Example 1 or 3.

| | Preparation | Parts of | q/m [μC/g] | | | |
|---|---|---|---|---|---|---|
| No. | Ex. | coloring agent | 5 min | 10 min | 30 min | 2 h |
| 27 | 1 | 2 | −16 | −15 | −14 | −14 |
| 28 | 3 | 2 | −19 | −18 | −17 | −16 |

### COMPARISON EXAMPLE A

The procedure is as in Use Example 1a and 1b, but instead of the compound from Preparation Example 1, the corresponding compound is employed without the hydrophobizing step according to the invention:

Comparison Example A

| | |
|---|---|
| according to 1a | according to 1b |

| | |
|---|---|
| Duration of activation | charging q/m [μC/g] |

| | | |
|---|---|---|
| 5 min | −16 | −5 |
| 10 min | −16 | −5 |
| 30 min | −17 | — |
| 2 h | −16 | — |

The tribocharging under high atmospheric humidity conditions is significantly less pronounced than in the case of the product according to the invention.

### COMPARISON EXAMPLE B

The procedure is as in Use Example 1a and 1b, but instead of the compound from Preparation Example 1, the corresponding compound is employed without the hydrophobizing step according to the invention, but with the addition of 2 wt. %, based on the total weight of the toner, of pulverulent wax (Licowax F, Clariant) into the binder system:

Comparison Example B

| | |
|---|---|
| according to 1a | according to 1b |

| | |
|---|---|
| Duration of activation | Charging q/m [μC/g] |

| | | |
|---|---|---|
| 5 min | −15 | −5 |
| 10 min | −16 | −6 |
| 30 min | −16 | — |
| 2 h | −16 | — |

The tribocharging under high atmospheric humidity conditions is significantly less pronounced than in the case of the product according to the invention. This means that the separate addition of the pulverulent wax shows no hydrophobizing effects at all in respect of the tribocharging, although it is even employed in a much higher amount than in Preparation Example 1.

1) A hydrophobic salt-like structured silicate, wherein the cation of the salt-like structured silicate is a low molecular weight organic cation or a combination thereof with NH₄⁺, H₃O⁺, an alkali metal ion, alkaline earth metal ion, earth metal ion a transition metal ion or a mixture thereof, wherein the anion of the salt-like structured silicate is an island, ring, group, chain, band, layer or three-dimensional silicate or a combination thereof, made by a process comprising the steps of
(a) reacting a structured silicate, the cation of which is NH₄⁺, H₃O⁺, an alkali metal ion, alkaline earth metal ion, earth metal ion, a transition metal ion or a combination thereof, and the anion of which is an island, ring, group, chain, band, layer or three-dimensional silicate or a combination thereof, with a low molecular weight organic cation in aqueous dispersion, and
(b) at least one of before, during or after step (a), adding to the aqueous dispersion of the structured silicate one or more hydrophobic compounds selected from the group consisting of waxes and metal soaps in an amount of from 0.2 to 200 wt. %, based on the salt-like structured silicate, wherein step (b) includes intensive thorough mixing of the aqueous dispersion of the structured silicate and the one or more hydrophobic compounds, and
(c) optionally freeing the hydrophobic salt-like structured silicate formed in step (b) from the liquid medium, drying the hydrophobic salt-like structured silicate and isolating the hydrophobic salt-like structured silicate a powder.

2) The hydrophobic salt-like structured silicate as claimed in claim 1, wherein the silicate is an anion selected from the group consisting of montmorillonite, bentonite, hectorite, kaolinite, serpentine, talc, pyrophyllite, mica, phlogopite, biotite, muscovite, paragonite, vermiculite, beidellite, xantophyllite, margarite, feldspar, zeolite, wollastonite, actinolite, amosite, crocidolite, sillimanite, nontronite, smectite, sepiolite, saponite, faujasite, permutite and sasil.

3) The hydrophobic salt-like structured silicate as claimed in claim 1, wherein the low molecular weight organic cation is a substituted ammonium, phosphonium, thionium, triphenylcarbonium ion or a cationic metal complex.

4) The hydrophobic salt-like structured silicate as claimed in claim 1, wherein the wax is a compound selected from the group consisting of acid waxes, ester waxes, amide waxes, carnauba waxes, polyolefin waxes, polyolefin degradation waxes, oxidized PE, PP or paraffin waxes, PP waxes modified by grafting with monomers, polyolefin metallocene waxes and paraffin waxes or a mixture thereof.

5) The hydrophobic salt-like structured silicate as claimed in claim 1, wherein the metal soap is a compound selected from the group consisting of di-, tri- or tetravalent metals salts of saturated or unsaturated C₇-C₄₃-carboxylic acids, C₈-C₄₄-sulfates, C₈-C₄₄-alkyl ether-sulfates, C₈-C₄₄-alkylamido ether-sulfates, C₈-C₄₄-alkylsulfonates, C₈-C₄₄-aralkylsulfonates (wherein aryl is C₆-C₁₂ and alkyl is C₁-C₃₂, C₈-C₄₄-alkyl ether-sulfosuccinates, C₈-C₄₄-acylglutamates, C₈-C₄₄-fatty acid isethionates, C₈-C₄₄-fatty acid methyltaurides, C₈-C₄₄-fatty acid sarcosides, C₈-C₄₄-phosphates, acid waxes, partly esterified acid waxes, partly hydrolyzed ester waxes, oxidized PE and paraffin waxes.

6) The hydrophobic salt-like structured silicate as claimed in claim 1, wherein the metal soap is a compound selected from the group consisting of monovalent metal salts of saturated or unsaturated C₇-C₄₃-carboxylic acids, C₈-C₄₄-sulfates, C₈-C₄₄-alkyl ether-sulfates, C₈-C₄₄-alkylamido ether-sulfates, C₈-C₄₄-alkylsulfonates, C₈-C₄₄-aralkylsulfonates (wherein aryl is C₆-C₁₂ and alkyl is C₁-C₃₂, C₈-C₄₄-alkyl ether-sulfosuccinates, C₈-C₄₄-acylglutamates, C₈-C₄₄-fatty acid isethionates, C₈-C₄₄-fatty acid methyltaurides, C₈-C₄₄-fatty acid sarcosides, C₈-C₄₄-phosphates, acid waxes, partly esterified acid waxes, partly hydrolyzed ester waxes, oxidized PE and paraffin waxes.

7) The hydrophobic salt-like structured silicate as claimed in claim 1, wherein the one or more hydrophobic compounds are present in an amount of from 1 to 100 wt. %, based on the salt-like structured silicate.

8) The hydrophobic salt-like structured silicate as claimed in claim 1, wherein, in step (b), the one or more hydrophobic compounds are added as a solution or aqueous dispersion at a temperature of between 20 and 200° C.

9) The hydrophobic salt-like structured silicate as claimed claim 1, wherein, in step (b), the one or more hydrophobic compounds are added as a melt in a fine jet over a period of time of at least 1 minute at a temperature of between 20 and 200° C.

10) A process for the preparation of a hydrophobic salt-like structured silicate comprising the steps of:
(a) reacting a structured silicate, the cation of which is NH₄⁺, H₃O⁺, an alkali metal ion, alkaline earth metal ion, earth metal ion, a transition metal ion or a combination thereof, and the anion of which is an island, ring, group, chain, band, layer or three-dimensional silicate or a combination thereof, with a low molecular weight organic cation in aqueous dispersion, and
(b) at least one of before, during or after step (a), adding to the aqueous dispersion of the structured silicate one or more hydrophobic compounds selected from the group consisting of waxes and metal soaps in an amount of from 0.2 to 200 wt. %, based on the salt-like structured silicate wherein step (b) includes intensive thorough mixing of the aqueous dispersion of the structured silicate and the one or more hydrophobic compounds, and
(c) optionally freeing the hydrophobic salt-like structured silicate formed in step (b) from the liquid medium, drying the hydrophobic salt-like structured silicate and isolating the hydrophobic salt-like structured silicate as a powder.

11) The process as claimed in claim 10, wherein step (b) is carried out in the presence of a dispersing auxiliary.

12) The process as claimed in claim 10, wherein in step (b), the one or more hydrophobic compounds are di- to tetravalent metal soaps or a combination thereof and wherein the di- to tetravalent metal soaps are produced in the reaction mixture only after addition to the aqueous dispersion of the structured silicate, by precipitation of the corresponding acid components with the di- to tetravalent metal salt and, optionally, adjusting the pH between 2 and 11.

13) A charge controlling agent for electrophotographic toners, electrophotographic developers, powder coatings, electret materials, electronic inks, electronic papers and in electrostatic separation operations comprising a hydrophobic salt-like structured silicate made in accordance with the process of claim 10.

14) An external additive to powder toners for controlling the flowability and the charge comprising a hydrophobic salt-like structured silicate made in accordance with the process of claim 10.

15. An anti-offset agent in electrophotographic toners or powder toners comprising a hydrophobic salt-like structured silicate made in accordance with the process of claim 10.

16. A hydrophobic salt-like structured silicate made in accordance with the process of claim 10.
